(19) United States
(12) Patent Application Publication
(10) Pub. No.: US 2022/0330641 A1
(43) Pub. Date: Oct. 20, 2022

(54) BODY SIZE MEASURING DEVICE FOR CUSTOMIZED UNDERWEAR PRODUCTION AND SYSTEM THEREFOR

(71) Applicant: Jang Yul YEOM, Seoul (KR)

(72) Inventor: Jang Yul YEOM, Seoul (KR)

(21) Appl. No.: 17/829,944

(22) Filed: Jun. 1, 2022

Related U.S. Application Data
(63) Continuation of application No. PCT/KR2020/000667, filed on Jan. 14, 2020.

(30) Foreign Application Priority Data
Dec. 6, 2019 (KR) 10-2019-0161847

(51) Int. Cl. A41H 1/02; G06Q 30/06

(52) U.S. Cl. CPC A41H 1/02; G06Q 30/0621

(57) ABSTRACT

In a body size measuring device for customized underwear production and a system therefor, for a customer who desires customized underwear production, a 3D body shape of the customer is generated using a 3D scanner, points required for the customized underwear production is selected from among all points forming the 3D body shape, thereby calculating coordinate data values and the like of the selected points, and the customer's body size information is more accurately calculated on the basis of the coordinate data values of the respective points. As a result, it is possible to produce underwear that fits the customer's body more comfortably than commercially available underwear produced by manufactures in a standardized manner, thereby contributing to increased customer satisfaction.

### TECHNICAL FIELD

The present disclosure relates to the manufacture of underwear and, more particularly, to a body size measuring device and system for customized underwear production, which create a 3D body shape of the customer using a 3D scanner, select points required for customized underwear production among all the points that make up the 3D body shape, calculate coordinate data values of the selected points, and calculate body size information of the customer more accurately based on the coordinate data values of the respective points.

### BACKGROUND

Underwear generally refers to items of clothing such as bras and panties which is worn for the purpose of covering and protecting the genitals.

Underwear is clothing that is in direct contact with the skin, for which comfort and fit should be considered key. However, in the current mass-production situation, underwear is produced only in a select set of sizes according to a limited number of standards, without taking into account individuals' different body shapes at all.

This leaves customers no other option but to pick out an item they think most fit their body shape from a usual collection of underwear that come in fixed sizes, and thus it is hard to expect that the customers will get satisfaction in comfort and fit when they wear it. Moreover, each underwear brand has a different standard for underwear sizes, making the sizes slightly different from other brands, and the customer will find it difficult to choose the right size.

Among underwear, especially bras, which are worn by women, do not come in various sizes. Nowadays, more and more bras are made to push the breasts up and together, with designs focusing on aesthetic appeal, but customers wearing these bras tend to have low satisfaction in comfort and fit.

For example, wearing bras on a daily basis may cause a lot of stress on the woman's body, and this stress can be the cause of symptoms such as indigestion, restricted breathing, impediment to blood flow, and so on and even deform the woman's body. This can happen when women wear the wrong bra size for a long period of time under the current circumstances where there is no customized underwear available in the market.

Men also often feel discomfort from underwear which they wear every day and all day long, because the underwear is not custom-made for individuals no matter what size they find that appears to best fit their body. For example, one may feel discomfort on the waist wearing an L size, while other people wearing this L size may feel loose on the thighs. Or else, in some men, the same L size may be tight on the thighs but loose on the waist, or may feel discomfort only on the buttocks.

Meanwhile, many companies are recently emerging to manufacture underwear in various sizes in order to resolve the customer satisfaction with the current underwear sizing systems. However, given the increase in the cost of manufacturing underwear in various sizes, there has been no significant improvement in customer satisfaction.

In view of this, customized underwear may be manufactured based on each customer's correct body size information which is correctly calculated by three-dimensionally scanning the customer's body, with an anticipation that customer satisfaction will be improved a lot, and that the problem of inventory in mass production will be solved.

### SUMMARY

Accordingly, the present disclosure is to provide a body size measuring device and system for customized underwear production, which, for a customer who wants to make a customized underwear, creates a three-dimensional (3D) body shape of the customer using a 3D scanner, selects points required for customized underwear production among all the points making up the 3D body shape, calculates coordinate data values of the selected points, and generates body size information of the customer based on the coordinate data value of each point.

The aspects of the present disclosure are not limited to the above-mentioned one, and other aspects and advantages not mentioned herein will be understood by the following description and more clearly understood by embodiments of the present disclosure. It will also be readily apparent that the aspects and advantages of the present disclosure may be implemented by means described in claims and a combination thereof.

In accordance with an aspect of the present disclosure, there is provided a body size measuring device for manufacturing customized underwear for a customer, including: a communication unit connected through a wired/wireless communication network to an underwear manufacturing server that manages authentication information registered as a member of the customer to transmit and receive data; a key input unit provided with a plurality of function keys for performing various operations of the body size measuring device; a display unit configured to display operation state information of the body size measuring device according to a key input through the key input unit; a customer authentication unit serving to authenticate whether the customer is a registered customer by accessing the underwear manufacturing server through the communication unit when there is a request for body size measurement from the customer; a three-dimensional (3D) scan unit configured to three-dimensionally scan a body of the customer to generate a 3D body shape of the customer when there is a key input for requesting body size measurement from the customer through the key input unit in a state in which the customer is authenticated as a registered customer; a body size calculation unit that selects a preset number of points necessary for designing underwear suitable for a body shape of the customer from points making up the 3D body shape, and calculates body size information of the customer for manufacturing customized underwear based on a data value of each of the selected points; and a housing in which the customer enters and stands in a stationary state or through which the customer walks to pass, the 3D scanning unit being installed inside or outside of the housing to enable 3D scanning of the customer.

When there is a request for body size measurement from the customer, the customer authentication unit may receive authentication information from the customer through the key input unit, transmit the authentication information the underwear manufacturing server through the communication unit to transmit an authentication information confirmation request about whether the customer is a registered customer, and when receiving an authentication information confirmation response indicating that the customer is a registered customer through the authentication information from the underwear manufacturing server, authenticate the customer as a registered customer.

The body size calculation unit may transmit, when the body size information of the customer is calculated, the calculated body size information and the authentication information of the customer to the underwear manufacturing server through the communication unit, and the underwear manufacturing server may manage the body size information of the customer as body size information for the customer corresponding to the authentication information.

The body size calculation unit may select a preset number of points necessary for designing underwear suitable for the body shape of the customer from points making up the 3D body shape, calculates coordinates data values indicating positions on the 3D body shape of the customer for the respective selected points, calculate a plurality of body element information for customized underwear production based on the calculated coordinate data values, and calculate the plurality of body element information as the body size information of the customer.

The body size calculation unit may include: a first group point generating unit that extracts first area points making up a 3D body shape of a preset first area including the customer's bust from among all the points making up the 3D body shape of the customer, and generates first group points by selecting a plurality of points necessary for designing a first underwear suitable for the 3D body shape of the first area among the first area points; a second group point generating unit that extracts second area points making up a 3D body shape of a preset second area including the customer's crotch from all the points, and generates second group points by selecting a plurality of points necessary for designing a second underwear suitable for the 3D body shape of the second area among the second area points; and a body size generating unit that calculates a plurality of body element information for customized underwear production for the customer based on coordinate data values of the respective points included in the first group points and the second group points, and then calculates the plurality of body element information as the body size information of the customer.

The body element information may include first body element information necessary for designing the first underwear and second body element information necessary for designing the second underwear, wherein the first body element information includes data items of breast width (A1) (straight length between both nipple points (B.P)); distance between breasts (A2) (among equidistant points obtained by dividing the distance between a front length of bust circumference (A4) and a front length of lower bust circumference (C2) into 10 equal parts, a width between the breasts at the first to sixth points from the front length of bust circumferences (A4)); bust circumference (A3) (horizontal circumference line passing through the nipple points (B.P)); front length (A4) of the bust circumference (a length corresponding to a front side in the bust circumference with reference to a cross-section length (S.L) passing through the center of the body); back length (A5) of the bust circumference (a length corresponding to a back side in the bust circumference with reference to the cross-section length (S.L) passing through the center of the body); breast length (A6) (a length obtained by dividing ½ of the front length (B2) of the upper bust circumference into 20 equal parts and measuring a vertical length passing through B.P from one point selected among the sixth to fourteenth points along a curved line); breast thickness (A7) (a thickness of breast with reference to B.P); lower breast height (A8) (to a curved length from B.P to a bottom point of breast); front length of breast (A9) (a curved length from B.P to the distance between breasts (A2)); back length of breast (A10) (a horizontally measured curved distance from B.P to a point where a vertical line of an end point of an arm meets in the line corresponding to the front length of bust circumference (A4)); front length of breast circumference (A11) (a curved length of the lower bust circumference from one point selected between the fifth to tenth equidistant points, among points obtained by dividing a ½ length of the front length of lower bust circumference (C2) into 20 equal parts, to the distance between breasts (A2)); back length of breast circumference (A12) (a curve length of the lower breast circumference from one point selected between the fifth to tenth equidistant points, among points obtained by dividing a ½ length of the front length of lower bust circumference (C2) into 20 equal parts, to one point selected between the fourth to ninth equidistant points among points by dividing a vertical length between an end point of upper bust circumference (B1) and an end point of the front length of lower bust circumference (C2)); upper bust circumference (B1) (a horizontal circumference passing through an end point of an armpit); front length (B2) of the upper bust circumference (a length corresponding to the front side in the upper bust circumference with reference to S.L); back length (B3) of the upper bust circumference (a length corresponding to the back side in the upper bust circumference with reference to S.L), total shoulder width (B4) (a width between end points of left and right shoulder blades); shoulder length (B5) (a length from a most curved portion at the boundary between a neck and a shoulder to the end point of the shoulder blade); lower breast circumference (C1) (a horizontal circumference line at a point where the breast ends); front length of lower bust circumference (C2) (a length corresponding to the front side in the lower bust circumference C1 with reference to S.L); back length of lower bust circumference (C3) (a length corresponding to the back side in the lower bust circumference C1 with reference to S.L); breast length (D1) between shoulder and B.P (a vertical length from the seventh to fourteenth points in 20 equal parts of shoulder length (B5) to B.P) (a shoulder center point: a midpoint between a neck side point and an end point of the shoulder blade); and front shoulder strap length (D2) (a length connecting the seventh to fourteenth points in the 20 equal parts of the shoulder length (B5) to the fifth to tenth points in 20 equal parts of ½ length of the front length of upper bust circumference (B2)), wherein the first group points include a set of points necessary to generate the first body element information among the first area points, and wherein the body size generating unit generates a value of each data item included in the first body element information based on a coordinate data value of each point included in the first group points.

The second body element information may include: hip circumference 1 (H1) (a circumference at a most protruding point of the hip when viewed from the side); hip circumference 2 (H2) (a length corresponding to the front side of the hip circumference 1 with reference to S.L); hip circumference 3 (H3) (a length corresponding to the back side of the hip circumference 1 (H1) with reference to S.L); lower hip tip distance (H4) (a length of left and right spacing of intersection of hip length 1 (M1), hip length 2 (M2) and back length of thigh circumference (L2)); crotch upper width (J1) (a width at the point where the vulva starts in a standing posture with the legs spread to the width of the pelvis); minimum crotch width (J2) (a length of the width between the left and right sides of the thigh circumference (L1)); leg circumference (K1) (a leg circumference between the fourth to eighth points in 10 equal parts of a vertical interval between the belly circumference (O7) and hip circumference 1 (H1)); thigh circumference (L1) (a thigh circumference measured at a point 1 cm below a tip of the huckle bone (H.B)); back length of thigh circumference (L2) (a back circumference of thigh measured at a point just below the tip of the huckle bone (H.B)); hip length 1 (M1) (a length of a line connecting the sixth to tenth points among equidistant points obtained by dividing a ½ length of back length of belly circumference (O9) into 20 equal parts and the fifth to the tenth points among equidistant points obtained by dividing the back length of thigh circumference (L2) into 20 equal parts); hip length 2 (M2) (a length of a line connecting the sixth to tenth points among equidistant points obtained by dividing a ½ length of back length of lower belly circumference (O6) into 20 equal parts and the fifth to tenth points among equidistant points obtained by dividing the back length of thigh circumference (L2) into 20 equal parts); crotch length 1 (N1) (a length from the top of the crotch to lower belly circumference (O4)); crotch length 2 (N2) (to a length from the top of the crotch to belly circumference (O3)); waist circumference (O1) (a horizontal circumference of a narrowest portion of a waist when viewed from the front); front length of waist circumference (O2) (a length corresponding to the front side of the waist circumference (O1) with reference to S.L); back length of waist circumference (O3) (a length corresponding to the back side of the waist circumference (O1) with reference to S.L); lower belly circumference (O4) (a circumference between one selected point among the points obtained by dividing the vertical length between the waist circumference (O1) and the hip circumference 1 H1 into 20 equal parts and the fifth to twelfth equidistant points from the waist circumference (O1)); front length of lower belly circumference (O5) (a length corresponding to the front side of the lower belly circumference (O4) with reference to S.L); back length of lower belly circumference (O6) (a length corresponding to the back side of the lower belly circumference (O4) with reference to S.L); belly circumference (O7) (a circumference of a most protruding portion of a belly when viewed from a side); front length of belly circumference (O8) (a length corresponding to the front side of the belly circumference (O7) with reference to S.L), back length of belly circumference (O9) (a length corresponding to the back side of the belly circumference (O7) with reference to S.L); and length between pelvic bones (P1) (an interval between left and right pelvic bones), wherein the second group points include a set of points necessary to generate the second body element information among the second area points, and wherein the body size generating unit generates a value of each data item included in the second body element information based on a coordinate data value of each point included in the second group points.

The first body element information may further include: front neck length (D3) (a vertical length from a front neck point (F.N) to the upper bust circumference (B1)); armhole length (F1) (a length from shoulder end point to armpit end point (C.A)); armhole circumference (F2) (an arm circumference); shoulder strap side length (G1) (a curved length between an arm end line and a back arm end line with reference to the armpit end point (C.A)); back shoulder strap length (G2) (a length connecting the seventh to fourteenth points in 20 equal parts of the shoulder length (B5) and the fifth to tenth points in 20 equal parts of ½ length of the back length of bust circumference (A5)); back shoulder length (G3) (a length connecting the seventh to fourteenth points in 20 equal parts of the shoulder length B5 and the fifth to tenth points in 20 equal parts of ½ length the back length of under bust circumference C3), back length (I1) (a length from the center of the back neck point to the back length of under bust circumference (C3) in a back body center line (Center Back: C.B)); and front center length (2) (a length from the center of the front neck point to the front center of the under bust circumference in a front body center line (Center Front: C.F).

The housing may have a sealed interior space in which the customer stands, the interior space may include a first space in which the customer takes off clothes, and a second space separated from the first space through a space separation member to perform a 3D scan of the body of the customer, a foot plate on which the customer may be located for the 3D scan is placed in the center of the second space, the foot plate may be provided with a pressure sensor for sensing whether the customer is located, the 3D scanner three-dimensionally may scan the body of the customer only when it is confirmed that the customer is located on the foot plate through the pressure sensor.

The first space may include an underwear storage part in which tapes or disposable measurement auxiliary underwear to be worn by the customer to assist in measuring the body shape of the customer are stacked, and an underwear collection part that collects the tape or the disposable measurement auxiliary underwear worn by the customer during a 3D scan.

The underwear storage part may include a plurality of storage shelves, the disposable measurement auxiliary underwear may include a first auxiliary underwear for assisting body shape measurement for manufacture of the first underwear, and a second auxiliary underwear for assisting body shape measurement for manufacture of the second underwear, and the first auxiliary underwear and the second auxiliary underwear may be manufactured by a plurality of pre-classified reference body types, and be divided and stacked for each reference body type on the plurality of storage shelves.

The key input unit may further include a biometric information input unit capable of inputting biometric information of the customer, when there is a key input for requesting body size measurement from the customer through the key input unit in a state that the customer is authenticated as a registered customer, the 3D scan unit may receive the biometric information of the customer through the biometric information input unit and provides the biometric information of the customer to the body size calculation unit, the body size calculation unit may transmit, when the body size information of the customer is calculated, the calculated body size information of the customer, the authentication information, and the biometric information to the underwear manufacturing server through the communication unit, and the underwear manufacturing server may store the biometric information and the body size information of the customer associated with each other, and when there is a request for the body size information from the customer, requests the customer to transmit the biometric information together with the authentication information and provides the body size information to the user terminal of the customer when both the authentication information and the biometric information match.

The plurality of storage shelves may be coated with an antibacterial material, and the material may be formed by mixing 0.5 to 0.7 parts by weight of a silver-based inorganic antibacterial agent, which is an agglomerate of silver ions and inorganic metal ions, based on 100 parts by weight of a fluororesin.

The underwear storage part may have a door for blocking an area in which the disposable measurement auxiliary underwear or tapes are stacked from an outside, the door may be opened or closed by a physical force of the customer, and an ultraviolet irradiation unit may be provided at one side of the underwear storage part, the ultraviolet irradiation unit irradiating ultraviolet rays to the disposable measuring auxiliary underwear or tapes stacked in the underwear storage part when the door is closed.

In accordance with another aspect of the present disclosure, there is provided a body size measuring system for manufacturing customized underwear for a customer, a user terminal of a customer through which the customer accesses an underwear manufacturing server implemented on a wired/wireless communication network to register as a member; an underwear manufacturing server that registers the customer, who wants to produce customized underwear, according to member information input from the user terminal as a member, and manages body size information of the customer registered as a member; and a body size measuring device for three-dimensionally scanning a body of the customer, generating the body size information of the customer for manufacturing the customized underwear, and transmitting the body size information to the underwear manufacturing server, wherein the body size measuring device includes: a communication unit connected through a wired/wireless communication network to an underwear manufacturing server that manages authentication information registered as a member of the customer to transmit and receive data; a key input unit provided with a plurality of function keys for performing various operations of the body size measuring device; a display unit configured to display operation state information of the body size measuring device according to a key input through the key input unit; a customer authentication unit serving to authenticate whether the customer is a registered customer by accessing the underwear manufacturing server through the communication unit when there is a request for body size measurement from the customer; a three-dimensional (3D) scan unit configured to three-dimensionally scan a body of the customer to generate a 3D body shape of the customer when there is a key input for requesting body size measurement from the customer through the key input unit in a state in which the customer is authenticated as a registered customer; a body size calculation unit that selects a preset number of points necessary for designing underwear suitable for a body shape of the customer from points making up the 3D body shape, and calculates body size information of the customer for manufacturing customized underwear based on a data value of each of the selected points; and a housing in which the customer enters and stands in a stationary state or through which the customer walks to pass, the 3D scanning unit being installed inside or outside of the housing to enable 3D scanning of the customer.

The body size calculation unit may transmit, when the body size information of the customer is calculated, the calculated body size information and the authentication information of the customer to the underwear manufacturing server through the communication unit, and the underwear manufacturing server may manage the body size information of the customer as body size information for the customer corresponding to the authentication information.

The body size calculation unit selects a preset number of points necessary for designing underwear suitable for the body shape of the customer from all the points making up the 3D body shape, calculates coordinates data values indicating positions on the 3D body shape of the customer for the respective selected points, calculates a plurality of body element information for customized underwear production based on the calculated coordinate data values, and calculates the plurality of body element information as the body size information of the customer.

The body size calculation unit may include: a first group point generating unit that extracts first area points making up a 3D body shape of a preset first area including the customer's bust from among all the points making up the 3D body shape of the customer, and generates first group points by selecting a plurality of points necessary for designing a first underwear suitable for the 3D body shape of the first area among the first area points; a second group point generating unit that extracts second area points making up a 3D body shape of a preset second area including the customer's crotch from all the points, and generates second group points by selecting a plurality of points necessary for designing a second underwear suitable for the 3D body shape of the second area among the second area points; and a body size generating unit that calculates a plurality of body element information for customized underwear production for the customer based on coordinate data values of the respective points included in the first group points and the second group points, and then calculates the plurality of body element information as the body size information of the customer.

When there is a request for body size measurement from the customer, the customer authentication unit may receive authentication information from the customer through the key input unit, transmit the authentication information the underwear manufacturing server through the communication unit to transmit an authentication information confirmation request about whether the customer is a registered customer, and when receiving an authentication information confirmation response indicating that the customer is a registered customer through the authentication information from the underwear manufacturing server, authenticate the customer as a registered customer.

According to one embodiment of the present disclosure, in the body size measuring device and system for customized underwear production, it is possible to, for a customer who wants to make a customized underwear, create a 3D body shape of the customer using a 3D scanner, select points required for customized underwear production among all the points that make up the 3D body shape, calculate coordinate data values of the selected points, and calculate body size information of the customer more accurately based on the coordinate data values of the respective points.

The specific effects of the present disclosure as well as the above-described effects will be described together while describing details of embodiments of the present disclosure below.

### BRIEF DESCRIPTION OF THE DRAWINGS

FIG. 1 is a configuration diagram of a network of a body size measuring system for customized underwear production.

FIG. 2 is an exemplary view of a 3D body shape of a customer created in a body size measuring device according to one embodiment of the present disclosure.

FIG. 3 is an exemplary view of a 3D body shape of a customer created in a body size measuring device according to one embodiment of the present disclosure.

FIG. 4A is an exemplary view of body element information that may be generated by a first group point and a second group point according to one embodiment of the present disclosure.

FIG. 4B is an exemplary view of body element information that may be generated by a first group point and a second group point according to one embodiment of the present disclosure.

FIG. 5 is a cross-sectional view of a housing of the body size measuring device housing according to one embodiment of the present disclosure.

FIG. 6 is a detailed block diagram of the body size measuring device according to one embodiment of the present disclosure.

FIG. 7 is an operation control flowchart for calculating body size information from a customer's 3D body shape in the body size measuring device according to one embodiment of the present disclosure.

FIG. 8 is a detailed configuration diagram of an underwear storage part according to one embodiment of the present disclosure.

FIG. 9 is an exemplary view of dividing a chest area for making a 3D bra pattern according to one embodiment of the present disclosure.

### DETAILED DESCRIPTION OF THE EMBODIMENTS

Hereinafter, operating principles of the present disclosure will be described fully with reference to the accompanying drawings. While describing the disclosure, detailed description of related well-known functions or configurations may be omitted when it is deemed that they may unnecessarily obscure the essence of the disclosure. Also, terms used below are defined in consideration of functions in the disclosure, and may have different meanings according to an intention of a user or operator, customs, or the like. Thus, the terms should be defined based on the description throughout the specification.

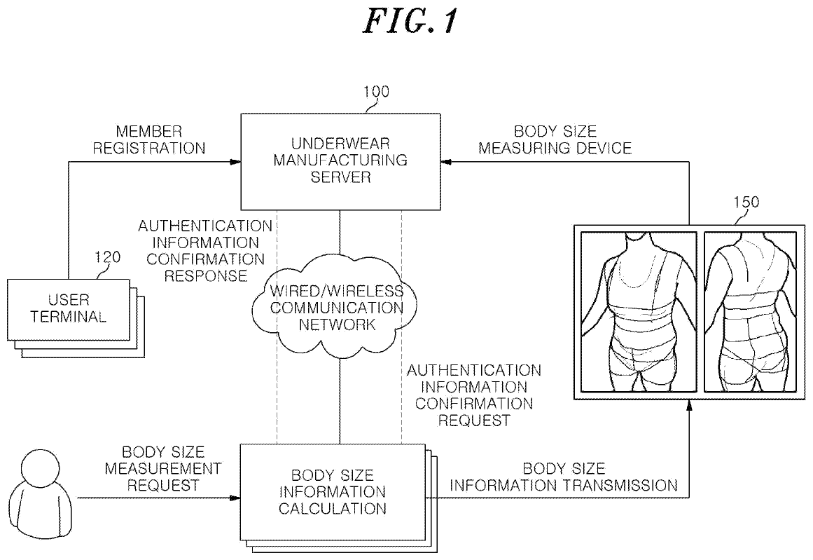

FIG. 1 shows a configuration diagram of a network of a body size measuring system for customized underwear production.

Hereinafter, with reference to FIG. 1, the operation of each element in the customer-customized underwear production system network according to one embodiment of the present disclosure will be described in more detail.

First, a user terminal 120 may refer to a wired or wireless terminal of a customer who accesses an underwear manufacturing server 100 connected to a wired/wireless communication network including the Internet to make a request for production of customized underwear.

The user terminal 120 may be, but not limited to, a communication device such as a computer equipped with a web browser or the like, a mobile communication terminal, a personal digital assistant (PDA), and a TV with an Internet access function.

That is, the customer may access a webpage or the like implemented for the sale of customized underwear in the underwear manufacturing server 100 using the user terminal 120. Then, the customer may sign up for the webpage, and input various kinds of order information required for the customized underwear production in an order entry box or the like provided on the webpage to make a request for customized underwear production as they like, for each underwear category such as bras, panties, and the like.

In this case, the customer sets an ID and password to access the underwear manufacturing server in the sign-up process as described above, and when the sign-up is normally performed, information such as the ID and password may be used as authentication information to access the underwear manufacturing server 100.

In this case, the above order information may be underwear category information, purchase number information, target underwear information, customer gender information, customer age information, and the like for the customized underwear requested for production.

In addition, the customer may access the webpage of the underwear manufacturing server 100 through the user terminal 120, select a desired category of underwear, such as a bra or panty, select a desired design in that category, and make a request for customized underwear production according to body size information based on a 3D body shape of his/her body registered on the underwear manufacturing server 100. In this case, the body size information of customers registered in advance in the underwear manufacturing server 100 is measured in advance by each customer in a body size measuring device 110 installed in department stores, swimming pools, various shopping malls, government offices, and the like according to one embodiment of the present disclosure, and the body size information of each customer measured by the body size measuring device 110 may be transmitted to and registered on the underwear manufacturing server 100 connected through a wired/wireless communication network, but the present disclosure is not limited thereto. Further, the body size measuring device 110 as described above is not limited to a type placed at fixed place, but may be a type mounted on a moving object such as a vehicle of a company that operates the underwear manufacturing server 100 to enable measurement at a place where a customer is located.

According to one embodiment of the present disclosure, the underwear manufacturing server 100 may refer to a server that is connected to the user terminal 120 and the body size measuring device 110 through a wired/wireless communication network such as the Internet to provide a customized underwear production service.

First, the underwear manufacturing server 100 may be connected to the body size measuring device 110 and a wired/wireless communication network, and for a customer registered as a member in the underwear manufacturing server 100, may register and manage the body size information of the customer measured by the body size measuring device 110.

In this case, in association with the body size measuring device 110, the underwear manufacturing server 100 may receive authentication information such as an ID and a password input by the customer from the body size measuring device 110 to check whether the customer is a customer registered as a member in the underwear manufacturing server 100. Accordingly, when the corresponding customer is normally authenticated, the body size measuring device 110 normally measures body size information for the customer, and the underwear manufacturing server 100 registers the customer's body size information transmitted from the body size measuring device 100 in association with the customer's member information so that when the customer requests the production of customized underwear, it will be possible to produce customized underwear for the customer's body shape based on the body size information registered for the customer.

The body size measuring device 110 may be connected to the underwear manufacturing server 100 through a wired/wireless communication network including the Internet.

The body size measuring device 110 may scan a body of a customer who wants to purchase customized underwear through a 3D scanner or the like to create a 3D body shape, select a preset number of points necessary to design underwear that fits the body shape of the customer, and calculate the customer's body size information required for the production of the underwear that fits the customer's body shape based on coordinate data values of the respective selected points and the like.

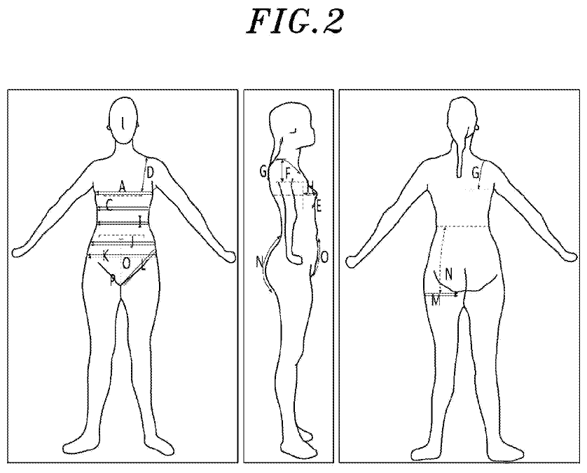

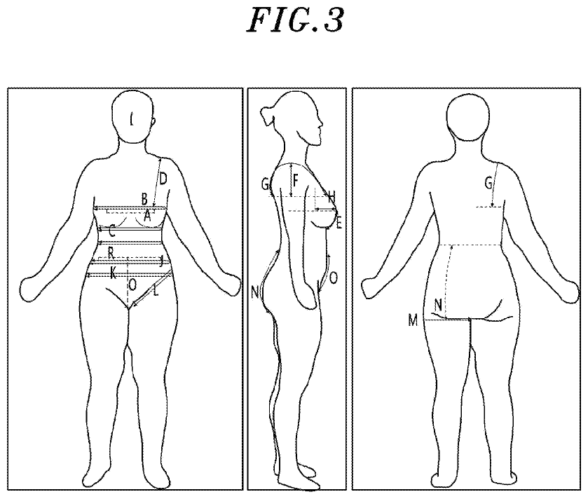

FIGS. 2 and 3 illustrate a 3D body shape of a customer created in the body size measuring device according to one embodiment of the present disclosure.

That is, although each customer has a different body shape as shown in FIGS. 2 and 3, in the prior art, regardless of the difference in the customer's body shape, underwear such as bra or panty has been produced using only basic information such as bust size, cup size, waist size, and hip size based on a specific model manufactured similarly to a human shape such as a mannequin, and the like, which results in low customer satisfaction.

Accordingly, in one embodiment of the present disclosure, the body size measuring device 110 for measuring a customer's 3D body shape is implemented, and in the body size measuring device 110, the body shape of the customer is accurately created as a 3D body shape as shown in FIGS. 2 and 3 through a 3D scanner or the like to calculate each customer's body size information based on the 3D body shape.

That is, the customer's body size information calculated by the body size measuring device 110 is calculated based on the customer's 3D body shape, and such body size information enables a 3D design of the customer's body, which makes it possible to produce customized underwear that fits the body shape of each customer.

In addition, in calculating the customer's body size information, the body size measuring device 110 selects a preset number of points necessary to design underwear for the customer's body shape among all points making up the customer's 3D body shape obtained through a 3D scan.

Subsequently, the body size measuring device 110 calculates a coordinate data value for each of the selected points on the customer's 3D body shape, calculates a plurality of body element information for customized underwear production based on the calculated coordinate data values, and then calculates the calculated body element information as the customer's body size information. In this case, the point may refer to each pixel making up the customer's 3D body shape, but is not limited thereto.

In addition, the operation of calculating the body size information described above will now be described in more detail. The body size measuring device 110 first extracts first area points making up a 3D shape of a preset first area including a customer's breast from all points making up the 3D body shape, and generates first group points by selecting a plurality of points necessary for designing first underwear suitable for the 3D shape of the first area from among the first area points.

Next, the body size measuring device 110 extracts second area points making up a 3D shape of a preset second area including a customer's crotch from all points, and generates second group points by selecting a plurality of points necessary for designing second underwear suitable for the 3D shape of the second area.

Subsequently, the body size measuring device 110 calculates a plurality of body element information for customized underwear production based on the coordinate data values of each of the points included in the first group points and the second group points, and then calculates the calculated body element information as the customer's body size information. Meanwhile, the body size information according to one embodiment of the present disclosure may include information on a length of a straight line or a curve connecting the points, and may include information on an area and a volume of a region made by a plurality of points in addition to the length of the straight line or the curve.

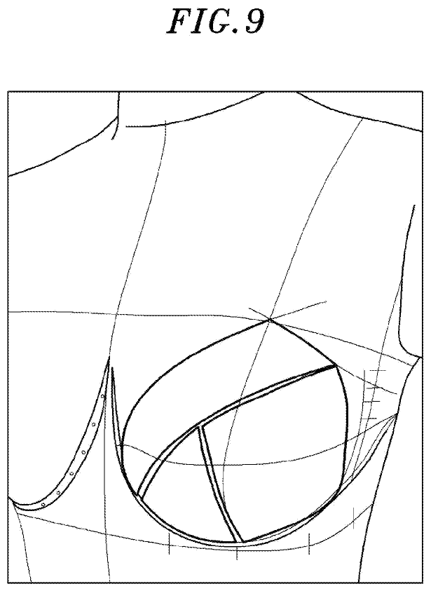

In this case, when dividing a breast area into three equal parts as shown in FIG. 9 for example, the area and the volume as described above are to enable the production of a 3D bra by calculating an area of each of the three equal parts through a scan.

In addition, the drawing illustrated in FIG. 9 is only an example, and a shape of a bra cup may be divided into three or more equal parts depending on a person, and the shapes of the parts may also vary.

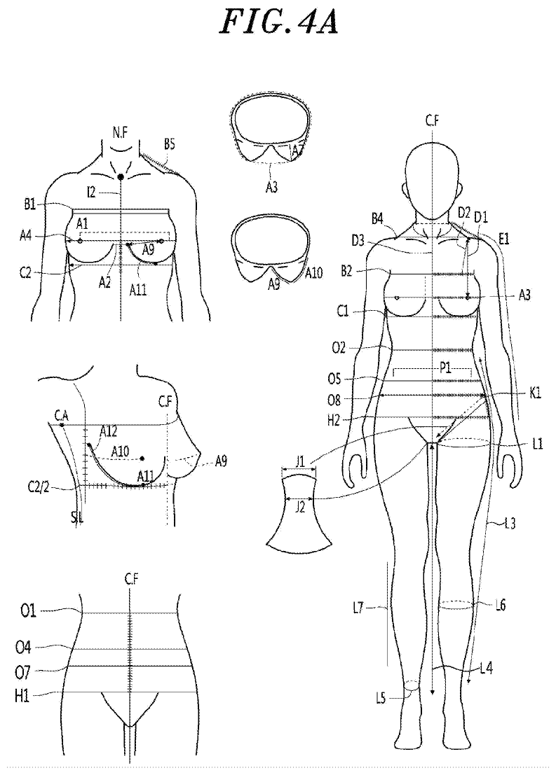

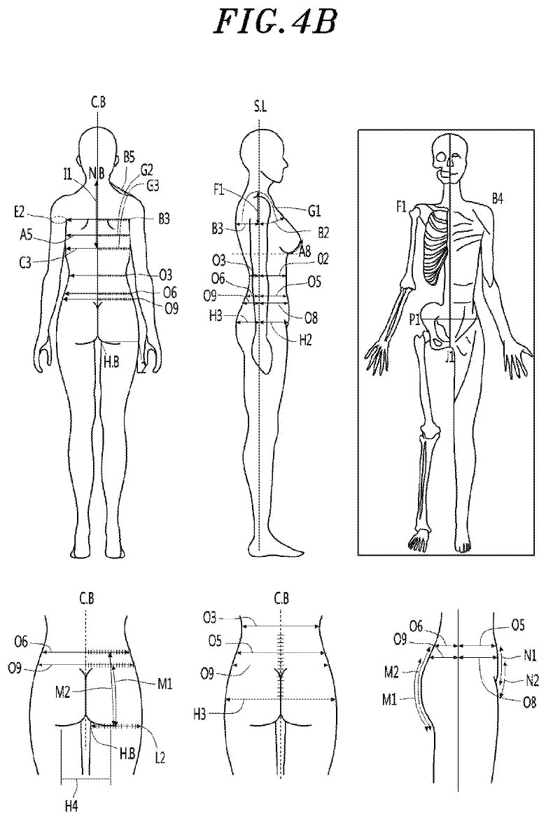

FIGS. 4A and 4B illustrate body element information that may be generated by the first group points and the second group points according to one embodiment of the present disclosure.

First, for example, in case that the underwear is a bra, the above body element information may include data items such as breast width A1, distance between breasts A2, bust circumference A3, front length of bust circumference A4, back length of bust circumference A5, breast length A6 (not shown), breast thickness A7, lower breast height A8, front length of breast A9, back length of breast A10, front length of breast circumference A11, back length of breast circumference A12, upper bust circumference B1, front length of upper bust circumference B2, back length of upper bust circumference B3, total shoulder width B4, shoulder length B5, lower bust circumference C1, front length of lower bust circumference C2, back length of lower bust circumference C3, breast length D1, front shoulder strap length D2, front neck length D3, arm length E1, forearm circumference E2, wrist circumference E3, armhole length F1, armhole circumference F2, shoulder strap side length G1, back shoulder strap length G2, back shoulder length G3, back length I1, front center length 12, and the like.

Among the data items above, breast length A6, lower breast height A8, front length of breast A9, back length of breast A10, front length of breast circumference A11, back length of breast circumference A12 are values measured along the curve of the customer's body as it is, and the first group points and the second group points may include points that enable measurement of the length of the curve among all points that make up the customer's 3D body shape. Accordingly, when the body size information according to one embodiment of the present disclosure is used, it is possible to produce customized underwear that fits the customer's body.

Here, the breast width A1 may refer to a straight length between both nipple points (B.P). The breast width A1 is a data item used in setting a high point to prevent a bra from being seen to spread, or setting a position to prevent the high point part from being left to be lifted by referring to the distance between the highest elevations of the bra.

The distance between breasts A2 may refer to the straight length between both breasts, and in particular, may refer to, among equidistant points obtained by dividing the distance between the front length of bust circumference A4 and the front length of lower bust circumference C2 into 10 equal parts, the width between the breasts at the first to sixth points from the front length of bust circumferences A4. The distance between breasts A2 is a data item for specifying a distance between starting points for holding the mold before a cup portion of the bra starts.

The bust circumference A3 may refer to a horizontal circumference line passing through the nipple points B.P. The bust circumference A3 is a data item for specifying a breast volume (e.g., A, B, C . . . cups).

The front length of bust circumference A4 may refer to a length corresponding to a front side in the bust circumference with reference to a cross-section length S.L passing through the center of the body. Among the bust circumference, the front length of bust circumference A4 is a data item for designating a pattern length of a front plate of a bra top, a sport type bra, a slip or the like.

The back length of bust circumference A5 may refer to a length corresponding to the back side body in the bust circumference with reference to the cross-section line S.L passing through the center of the. The back length of bust circumference A5 is a data item for designating the pattern length of a back plate of a bra top, a sports type bra, a slip or the like.

The breast length A6 may refer to a length measured, along a curved line, a vertical length passing through B.P from the upper bust circumference B1 to the lower bust circumference C1 and in particular, it may refer to a length obtained by dividing ½ of the front length of upper bust circumference B2 into 20 equal parts and measuring a vertical length passing through B.P from one point selected among the sixth to fourteenth points along a curved line. The breast length A6 is a data item for measuring a start position of a shoulder strap in consideration of the degree of wrapping the breast corresponding to the cup portion of the bra.

The breast thickness A7 may refer to the thickness of the breast with reference to B.P. The breast thickness A7 is a data item used as a reference for molding the fabric by setting the highest height of the cup portion.

The lower breast height A8 may refer to a curved length from B.P to a bottom point of breast. The lower breast height A8 is a data item for specifying the height of the lower cup among nonwoven fabric cup patterns.

The front length of breast A9 may refer to a curved length from B.P to the distance between breasts A2. The front length of breast A9 is a data item for identifying a location of B.P and setting the position of the cup height (height of the cup).

The back length of breast A10 may refer to a horizontally measured curved distance from B.P to a point where a vertical line of an end point of an arm meets in the line corresponding to the front length of bust circumference A4. The back length of breast A10 is a data item for identifying a location of B.P and setting a position of the cup height (height of the cup).

The front length of breast circumference A11 may refer to a curved length of the lower bust circumference from one point selected between the fifth to tenth equidistant points, among points obtained by dividing a ½ length of the front length of lower bust circumference C2 into 20, to the distance between breasts A2. The front length of breast circumference A11 is a data item for measuring the specifications of a wire or the degree of the front bust circumference and setting the front length or shape of the wire.

The back length of breast circumference A12 may refer to a curve length of the lower breast circumference from one point selected between the fifth to tenth equidistant points, among points obtained by dividing a ½ length of the front length of lower bust circumference C2 into 20, to the distance between breasts A2 to one point selected between the fourth to the ninth equidistant points among points by dividing a vertical length between the end point of the upper bust circumference B1 and the end point of the front length of lower bust circumference C2.

The upper bust circumference B1 may refer to a horizontal circumference passing through the end point of an armpit. The upper bust circumference B1 is a data item for the completion circumference of the upper bust portion for products such as a top-style bra, slip, and the like.

The front length of upper bust circumference B2 may refer to a length corresponding to the front side in the upper bust circumference with reference to S.L. The front length of upper bust circumference B2 is a data item for designating a front pattern length for products such as a top-style bra, slip, and the like.

The back length of upper bust circumference B3 may refer to a length corresponding to the back side in the upper bust circumference with reference to S.L. The back length of upper bust circumference B3 is a data item for designating a back pattern length for products such as a top-style bra, slip, and the like.

The total shoulder width B4 may refer to a width between the end points of left and right shoulder blades. The total shoulder width B4 is a data item for designating a boundary line between an arm and a shoulder of pajamas or the like.

The shoulder length B5 may refer to a length from the most curved portion at the boundary between a neck and a shoulder to the end point of the shoulder blade. The shoulder width length B5 is a data item for designating a boundary line between an arm and a shoulder of pajamas or the like.

The lower bust circumference C1 may refer to a horizontal circumference line at a point where the breast ends. The lower bust circumference C1 is a data item for designating a bottom support circumference (75, 80, 85, etc.) of a bra.

The front length of lower bust circumference C2 may refer to a length corresponding to the front side in the lower bust circumference C1 with reference to S.L. The front length of lower bust circumference C2 is a data item for setting a length of the bottom support portion that does not need to be expanded in the bra.

The back length of lower bust circumference C3 may refer to a length corresponding to the back side in the lower bust circumference C1 with reference to S.L. The back length of lower bust circumference C3 is a data item for setting a length of a wing part that needs to be stretched in the bra.

The breast length D1 between shoulder and B.P may refer to a vertical length from the seventh to fourteenth points in 20 equal parts of the shoulder length B5 to B.P (a shoulder center point: a midpoint between a neck side point and an end point of the shoulder blade). The breast length D1 between shoulder and B.P is a data item for setting a high position where the breast is located from the shoulder in the case of a bra top or a style where shoulder straps are not adjustable.

The front shoulder strap length D2 may refer to a length connecting the seventh to fourteenth points in the 20 equal parts of the shoulder length B5 to the fifth to tenth points in 20 equal parts of ½ length of the front length of upper bust circumference B2. The front shoulder strap length D2 is a data item for measuring a length of the front shoulder strap starting at the end of the cup portion of the bra.

The front neck length D3 may refer to a vertical length from a front neck point EN to the upper bust circumference B1. The front neck length D3 is a data item for measuring a depth degree of a neck line in a sports style bra or the like.

The arm length E1 may refer to a length from the shoulder end point to a start point of a protruding bone of a wrist. The arm length E1 is a data item for setting a total length of a sleeve of an upper part of innerwear, pajamas, or the like.

The forearm circumference E2 may refer to an arm circumference at an armpit end point (Center Armpit: C.A). The forearm circumference E2 is a data item for designating a sleeve width an upper part of innerwear, pajamas, or the like.

The wrist circumference E3 may refer to a circumference at the point where the bone of the wrist starts (a circumference of the narrowest part of the wrist). The wrist circumference E3 is a data item required to complete a cuff in an upper part of innerwear, pajamas, or the like.

The armhole length F1 may refer to a length from the shoulder end point to the armpit end point C.A. The armhole length F1 is a data item necessary to calculate an extra for giving comfort of movement with reference to the shoulder end point and the armpit end point in a pattern such as a sports type or pajamas. Here, the armpit point C.A may refer to a center point of an armpit fold line when raising the arm.

The armhole circumference F2 may refer to an arm circumference. The armhole circumference F2 is a data item for setting an arm circumference in a style (running-shirts type bra, pajamas, etc.) without shoulder strap adjustment.

The shoulder strap side length G1 may refer to a curved length between an arm end line and a back arm end line with reference to the armpit end point C.A. The shoulder strap side length G1 is a data item for setting the shoulder strap length in the case of a bra top.

The back shoulder strap length G2 may refer to a length connecting the seventh to fourteenth points in 20 equal parts of the shoulder length B5 and the fifth to tenth points in 20 equal parts of ½ length of the back length of bust circumference A5. The back shoulder strap length G2 is a data item for setting a bra shoulder strap of a general wing pattern.

The back shoulder length G3 may refer to a length connecting the seventh to fourteenth points in 20 equal parts of the shoulder length B5 and the fifth to tenth points in 20 equal parts of ½ length the back length of under bust circumference C3. The back shoulder length G3 is a data item for measuring a length of a shoulder strap in a U-shaped or back-wrapped bra.

The back length I1 may refer to a length from the center of the back neck point to the back length of under bust circumference C3 in a back body center line (Center Back: C.B). The back length I1 is a data item for setting a back center length of a sports bra, a running-shirts type bra, or the like.

The front center length 12 may refer to a length from the center of the front neck point to the front center of the under bust circumference in a front body center line (Center Front: C.F). The front center length 12 is a data item for setting a front center length of a sports bra and a running-shirts type bra, or the like.

Next, in case that the underwear is a panty for example, the above body element information may include data items such as a hip circumference 1 H1 (which is also referred to as a first hip circumference H1), a hip circumference 2 H2 (which is also referred to as a second hip circumference H2), a hip circumference 3 H3 (which is also referred to as a third hip circumference H3), a lower hip tip distance H4, and a crotch upper width J1, a minimum crotch width J2, a leg circumference K1, a thigh circumference L1, a back length of thigh circumference L2 (which is also referred to as a back thigh circumferential length), a total leg length L3, an inner leg length L4, an ankle circumference L5, a calf length L6, a hip length 1 M1 (which is also referred to as a first hip length M1), a hip length 2 M2 (which is also referred to as a second hip length M2), a crotch length 1 N1 (which is also referred to as a first crotch length N1), a crotch length 2 N2 (which is also referred to as a second crotch length N2), a waist circumference O1, a front length of waist circumference O2 (which is also referred to as a front circumferential waist length O2), a back length of waist circumference O3 (which is also referred to as a back circumferential waist length O3), a lower belly circumference O4, a front length of lower belly circumference O5 (which is also referred to as a front lower belly circumferential length O5), a back length of lower belly circumference O6 (which is also referred to as a back lower belly circumferential length O6), a belly circumference O7, a front length of belly circumference O8 (which is also referred to as a front belly circumferential length O8), a back length of belly circumference O9 (which is also referred to as a back belly circumferential length O9), and length between pelvic bones P1.

The hip circumference 1 H1 may refer to a circumference at the most protruding point of the hip when viewed from the side. The hip circumference 1 H1 is a data item for setting a hip circumference of a lower part in the innerwear.

The hip circumference 2 H2 may refer to a length corresponding to the front side of the hip circumference 1 with reference to S.L. The hip circumference 2 H2 is a data item for setting a front pattern length of the hip circumference of the lower part in the innerwear.

The hip circumference 3 H3 may refer to a length corresponding to the back side of the hip circumference 1 H1 with reference to S.L. The hip circumference 3 H3 is a data item for setting a back pattern length of the hip circumference of the lower part in the innerwear.

The lower hip tip distance H4 is a length between the intersection of the center line of each hip and the tip of the lower hip, that is, the left and right spacing of the intersection of the hip length 1 M1, the hip length 2 M2 and the back length of thigh circumference L2. The lower hip tip distance H4 is a data item for setting a connection length of the part where a back crotch and a back plate fabric meet in panties or for designating a width of a starting point wrapping the hip in the panties.

The crotch upper width J1 may refer to a width at the point where the vulva starts in a standing posture with the legs spread to the width of the pelvis. The crotch upper width J1 is a data item for designating a starting point of a groin line pattern in panties.

The minimum crotch width J2 may refer to a length of the width between the left and right sides of the thigh circumference L1. The minimum crotch width J2 is a data item for designating a width of the narrowest part of a crotch pattern.

The leg circumference K1 may refer to a leg circumference between the fourth to eighth points in 10 equal parts of the vertical interval between the belly circumference O7 and the hip circumference 1 H1, and a huckle bone H.B. The leg circumference K1 is a data item for designating a leg circumference of triangular panties.

The thigh circumference L1 may refer to a thigh circumference measured at a point 1 cm below the tip of the huckle bone H.B. The thigh circumference L1 is a data item for designating a leg circumference of a style (square shape) in which a height of a side line is low in innerwear bottoms.

The back length of thigh circumference L2 may refer to a back circumference of thigh measured at a point just below the tip of the huckle bone H.B. The back length of thigh circumference L2 is a data item that becomes a reference for finding points such as the lower hip tip distance H4, the hip length 1 M1, and the hip length 2 M2.

The total leg length L3 may refer to a length from a waist circumference point to a starting point of the ankle bone in the cross-section S.L passing through the center of the body. The total leg length L3 is a data item for setting a total length in the bottoms of underwear, pajamas, or the like.

The inner leg length L4 may refer to a length from the point where the crotch between the left and right legs ends to the ankle bone. The inner leg length L4 is a data item for setting a leg length in the bottoms of underwear, pajamas, or the like.

The ankle circumference L5 may refer to a circumference at the point where the ankle bone starts (the circumference of the narrowest part of the ankle). The ankle circumference L5 is a data item required to calculate a hem circumference in the bottoms of underwear, pajamas, or the like.

The calf circumference L6 may refer to a circumference at a point of ⅖ from the knee in the vertical length between the knee and the ankle. The calf circumference L6 is a data item required for a leg circumference pattern in the bottoms of underwear, pajamas, or the like.

The hip length 1 M1 may refer to a length of a line connecting the sixth to tenth points among equidistant points obtained by dividing a ½ length of the back length of belly circumference O9 into 20 equal parts and the fifth to the tenth points among equidistant points obtained by dividing the back length of thigh circumference L2 into 20 equal parts. The hip length 1 M1 is a data item for measuring a waist completion height of a pattern and setting a back length.

The hip length 2 M2 may refer to a length of a line connecting the sixth to tenth points among equidistant points obtained by dividing a ½ length of the back length of lower belly circumference O6 into 20 equal parts and the fifth to tenth points among equidistant points obtained by dividing the back length of thigh circumference L2 into 20 equal parts. The hip length 2 M2 is a data item for setting a back length of a style (high waist or pajamas) having a high waist completion height.

The crotch length 1 N1 may refer to a length from the top of the crotch to the lower belly circumference O2. The crotch length 1 N1 is a data item for setting a front length of a style (high waist or pajamas) having a high waist completion height.

The crotch length 2 N2 may refer to a length from the top of the crotch to the belly circumference O3. The crotch length 2 N2 is a data item for setting a front length of panties or the like.

The waist circumference O1 may refer to a horizontal circumference of the narrowest portion of the waist when viewed from the front. The waist circumference O1 is a data item that becomes a base for many products including waist points such as pajamas, high waist, running shirts, and the like.

The front length of waist circumference O2 may refer to a length corresponding to the front side of the waist circumference O1 with reference to S.L. The front length of waist circumference O2 is a data item required to designate a front pattern width at waist points of pajamas, bottom waist, running shirts, and the like.

The back length of waist circumference O3 may refer to a length corresponding to the back side of the waist circumference O1 with reference to S.L. The back length of waist circumference O3 is a data item required to designate a back pattern width at waist points of pajamas, bottom waist, running shirts, and the like.

The lower belly circumference O4 may refer to a circumference between one selected point among the points obtained by dividing the vertical length between the waist circumference O1 and the hip circumference 1 H1 into 20 equal parts and the fifth to twelfth equidistant points from the waist circumference O1. The lower belly circumference O4 is a data item for setting a waist banding completion size in panties.

The front length of lower belly circumference O5 may refer to a length corresponding to the front side of the lower belly circumference O4 with reference to S.L. The front length of belly circumference O5 is a data item for setting a front waist banding of panties or a width of the pattern.

The back length of lower belly circumference O6 may refer to a length corresponding to the back side of the lower belly circumference O4 with reference to S.L. The back length of waist circumference O6 is a data item for setting a back waist banding of panties or a width of the pattern.

The belly circumference O7 may refer to a circumference of the most protruding portion of the belly when viewed from the side. The belly circumference O7 is a data item for setting a waist banding completion size of panties with low crotch or a length of the pattern.

The front length of belly circumference O8 may refer to a length corresponding to the front side of the belly circumference O7 with reference to S.L. The front length of belly circumference O8 is a data item for setting a front waist completion size of panties with low crotch or a front length of the pattern.

The back length of belly circumference O9 may refer to a length corresponding to the back side of the belly circumference O7 with reference to S.L. The back length of belly circumference O9 is a data item for setting a back waist completion size of panties with low rise or a back length of the pattern.

The length between pelvic bones P1 may refer to an interval between left and right pelvic bones. The length between pelvic bones P1 is a data item for setting a pattern length of a front plate and a pattern length of a back plate so that a sewing line of a side line of panties does not meet the positions of the pelvis bones.

That is, the first group points and the second group points may include points necessary to calculate each data item of body element information among all points making up a 3D body shape of a person, as shown in FIGS. 4A and 4B.

In addition, the body size measuring device 110 may transmit the body size information measured for each customer to the underwear manufacturing server 100 as described above, so that the body size information of each customer is registered in the underwear manufacturing server 100. In this case, for example, the customer needs to register as a member in the underwear manufacturing server 100 before measuring his or her body size information in the body size measuring device 110 and may perform body size measurement after performing member authentication by inputting authentication information such as ID and password issued from the underwear manufacturing server 100.

Then, the body size measuring device 110 requests the customer who wants to measure the body size to input the ID and password registered in the underwear manufacturing server 100, confirms whether the customer is a legitimate member in association with the underwear manufacturing server 100 when the ID and password are input by the customer as authentication information, and generates body size information for the customer to send it to the underwear manufacturing server 100 if the customer is a legitimate member registered in the underwear manufacturing server 100.

At this time, the customer's body size information measured by the body size measuring device 110 is very personal information measured while the customer takes off clothes which requires security, it is preferable to be transmitted to the underwear manufacturing server 100 through encryption, and in the case of a 3D scanner for creating a body shape of a customer, it is preferable to be implemented to selectively scan only the part where the underwear would be worn.

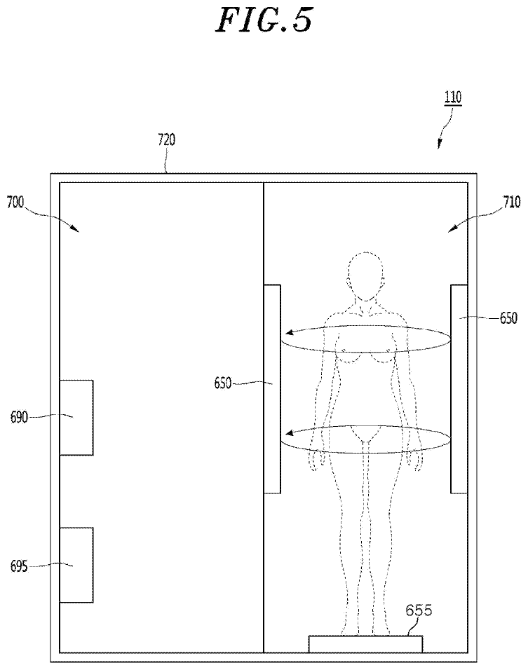

In addition, the body size measuring device 110 may include, for example, a housing 720 implemented in the form of a public telephone booth as shown in FIG. 5 showing a cross-sectional view of a body size measuring device housing 600. In the interior of the housing 720, inner spaces 700 and 710 where a person can enter and stand may be implemented, and the inner spaces may include a space for taking off and storing clothes and a space for performing a 3D scan, and the like.

In other words, the inner spaces 700 and 710 may include a first space 700 in which the customer takes off clothes, and a second space 710 in which a 3D scan of the customer's body is performed, the second space 710 being separated from the first space 700 through a space separation member.

In a central portion in the second space 710, a foot plate 655 on which a customer stands to perform a 3D scan may be located, and a pressure sensor (not shown) for sensing whether the customer is positioned on the foot plate 655 and a 3D scanner 650 for 3D scanning of the customer's body may be provided.

In this case, the 3D scanner 650 may be implemented to 3D scan the customer's body only when it is confirmed that the customer is positioned on the foot plate 655 through the pressure sensor, but the present disclosure is not limited thereto.

In addition, it is desirable to install the body size measuring device 110 at an arbitrary location of places with large floating populations such as department stores, shopping malls, swimming pools, various sports centers and public offices so that a customer who wants to obtain body size information based on a 3D body shape may easily access it. Further, the body size measuring device 110 as described above is not limited to a fixed place, but is mounted on a moving object such as a vehicle by a company that operates the underwear manufacturing server 100 to enable measurement at a location where a customer is located.

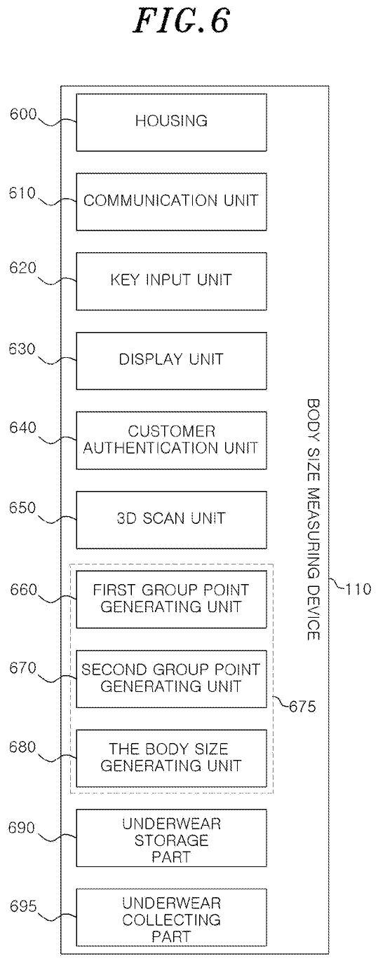

FIG. 6 illustrates a detailed block diagram of the body size measuring device according to one embodiment of the present disclosure.

Hereinafter, with reference to FIG. 6, the operation of each component of the body size measuring device for customized underwear production will be described in more detail.

First, the housing 600 is a space in which a 3D scan of a customer's body is performed in the body size measuring device 110, and may be implemented in the form of a public telephone booth as shown in FIG. 5, and Inner spaces 710 and 720 in which a person enters and stands may exist in the housing 720, and the inner space may include a space for taking off and storing clothes and a space for performing 3D scanning.

A communication unit 610 is connected to the underwear manufacturing server 100 that manages authentication information registered as a member of a customer through a wired/wireless communication network to transmit and receive data.

A key input unit 620 may include a plurality of function keys for performing various operations of the body size measuring device 110. When the key input unit 620 receives a key input such as authentication information for member authentication or 3D scan start request information from a customer for unique operation of the body size measuring device 110, key data according to the key input may be generated to be provided a customer authentication unit 640 or a 3D scan unit 650. The key input unit 620 may be implemented in a touch screen method, but is not limited thereto.

In addition, the key input unit 620 may further include a biometric information input unit through which biometric information of a customer can be input. The biometric information input unit may input biometric information of a customer such as a fingerprint, iris, or the like, and the biometric information input unit may be activated to receive biometric information from the customer during a 3D scan operation on the customer's body. The biometric information input unit provides biometric information to a body size calculation unit 675 when biometric information is input from the customer.

A display unit 630 displays various operation state information of the body size measuring device 110 according to a key input through the key input unit 620.

When a customer who enters the housing 600 of the body size measuring device 110 inputs a key input for requesting body size measurement using the key input unit 620 or the like, the customer authentication unit 640 accesses the underwear manufacturing server 100 through the communication unit 610 to authenticate whether the customer is a registered member through interworking with the underwear manufacturing server 100.

In other words, when there is a request for body size measurement from a customer, the customer authentication unit 640 receives authentication information from the customer through the key input unit 620, and transmits the input authentication information to the underwear manufacturing server 100 through the communication unit 610 to send a request for verification information about whether the customer is a registered customer. Then, when the customer authentication unit 640 receives an authentication information confirmation response indicating that the customer is a registered customer through authentication information from the underwear manufacturing server 100, the customer authentication unit 640 authenticates the customer as a registered customer. In this case, the authentication information may be a member ID and password set when a customer signs up in the underwear manufacturing server 100.

In addition, in the process of authenticating the registered customer, in order to increase security, the customer authentication unit 640 requests the customer, who is authenticated as a customer registered as a member through authentication information such as a member ID and password, to input biometric information (fingerprint, iris information, etc.) through the biometric information input unit (not shown) implemented on the input unit 620 before a 3D scan operation, and then transmit the customer's body size information to the underwear manufacturing server 100. Then, the underwear manufacturing server 100 stores the customer's body size information in association with the customer's biometric information, and requests a customer to input the biometric information along with the authentication information in the process of the customer requesting to check his or her body size information. The underwear manufacturing server 100 provides body size information only when biometric information also matches, which prevents exposure of the body size information of the customer that is very personal information to others even if authentication information such as the customer's ID and password are later exposed by malicious attacks.

The 3D scan unit 650 is installed in the second space 710 inside the housing 600, and in the case that there is a key input for requesting body size measurement from the customer through the key input unit 620 in a state in which the customer is authenticated as a registered customer, the 3D scan unit 650 performs a 3D scan on the customer's body to create a 3D body shape of the customer.

The body size calculation unit 675 selects a preset number of points required to design underwear suitable for the customer's body shape among all points making up the 3D body shape, and calculates body size information of the customer for customized underwear production based on the data value of each selected point.

That is, the body size calculation unit 675 selects a preset number of points required to design underwear suitable for the customer's body shape from all points making up the 3D body shape, and calculates a coordinate data value indicating a position on the customer's 3D body shape for each selected point. Subsequently, the body size calculation unit 675 may calculate a plurality of body element information for customized underwear production based on the calculated coordinate data value, and then calculate the plurality of body element information as body size information of the customer.

In addition, when the customer's body size information is calculated as described above, the body size calculation unit 675 transmits the customer's body size information and the customer's authentication information to the underwear manufacturing server 100 so that the 3D body shape-based body size information calculated for the authenticated customer can be registered in the underwear manufacturing server 100. Then, the underwear manufacturing server 100 manages the customer's body size information as body size information for the customer corresponding to the authentication information.

In addition, when the customer's body size information is calculated, the body size calculation unit 675 may transmit the customer's body size information, the authentication information, and the biometric information to the underwear manufacturing server 100.

Then, the underwear manufacturing server 100 stores the customer's biometric information and the customer's body size information in association with each other, and then, when there is a request for body size information from the customer, the underwear manufacturing server 100 requests the transmission of the biometric information together with the authentication information and provides the body size information of the corresponding customer measured by the body size measuring device 110 to the user terminal 120 of the customer in the case that both the authentication information and the biometric information match.

Specifically, the body size calculation unit 675 may include a first group point generating unit 660, a second group point generating unit 670, a body size generating unit 680, and the like.

The first group point generating unit 660 extracts first area points making up a 3D body shape of a preset first area including a customer's bust from all points making up a 3D body shape of the customer. Subsequently, the first group point generating unit 660 generates first group points by selecting a plurality of points necessary for designing a first underwear suitable for the 3D body shape of the first area among the first area points. In this case, the first underwear may be, for example, a “bra” worn by a woman on a bust, but is not limited thereto.

The second group point generating unit 670 extracts second area points making up a 3D body shape of a preset second area including a customer's crotch from all the points. Subsequently, the second group point generating unit 670 generates second group points by selecting a plurality of points necessary for designing a second underwear suitable for the 3D body shape of the second area among the second area points. In this case, the second underwear may be, for example, “panties” or the like, but is not limited thereto.

The body size generating unit 680 calculates a plurality of body element information for customized underwear production based on coordinate data values of the respective points included in the first group points and the second group points, and then calculates the plurality of body element information as body size information of the customer.

In this case, for example, in case that the underwear is a bra, the above body element information may include data items such as breast width A1, distance between breasts A2, bust circumference A3, front length of bust circumference A4, back length of bust circumference A5, breast length A6, breast thickness A7, lower breast height A8, front length of breast A9, back length of breast A10, front length of breast circumference A11, back length of breast circumference A12, upper bust circumference B1, front length of upper bust circumference B2, under bust circumference C1, front length of under bust circumference C2, back length of under bust circumference C3, breast length D1 between shoulder and B.P, front shoulder strap length D2, front neck length D3, arm length E1, forearm circumference E2, wrist circumference E3, armhole length F1, armhole circumference F2, shoulder strap side length G1, back shoulder strap length G2, back shoulder length G3, and the like.

In addition, for example, in case that the underwear is panties, the above body element information may include data items such as hip circumference 1 H1, lower hip tip distance H4, back length IL front center length 12, crotch upper width J1, minimum crotch width J2, leg circumference K1, thigh circumference L1, back length of thigh circumference L2, total leg length L3, inner leg length L4, ankle circumference L5, calf length L6, hip length 1 M1, hip length 2 M2, crotch length 1 N1, crotch length 2 N2, waist circumference O1, lower belly circumference O4, belly circumference O7, length between pelvic bones P1, and the like.

That is, the body size generating unit 680 generates a value of each data item included in the body element information based on the coordinate data values of the respective points included in the first group points and the second group points.

An underwear storage part 690 may be formed at one side in the first space 700, and disposable measurement auxiliary underwear or tapes that may be worn to assist the customer in measuring the shape of the body are stacked. An underwear collecting part 695 may be formed at the other side in the first space 700 and collects the disposable measurement auxiliary underwear or tape worn by the customer during the 3D scan.

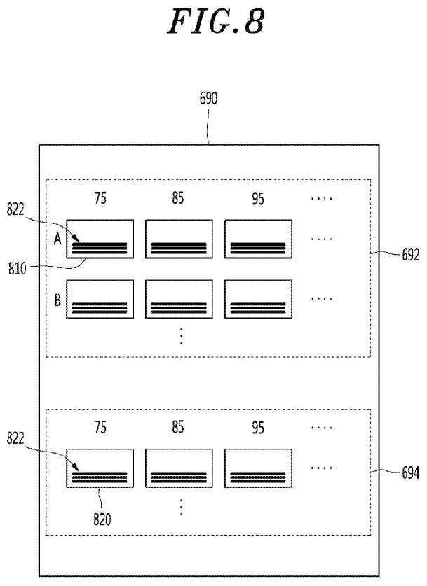

In addition, as shown in FIG. 8, the underwear storage part 690 may include a plurality of storage shelves 810 and 820 capable of storing disposable measurement auxiliary underwear or tapes with different sizes.

In addition, the disposable measurement auxiliary underwear may be divided into a first auxiliary underwear 812 for body shape measurement assistance to manufacture the first underwear such as a bra, bra top, and the like provided on each storage shelf located in the first area 692 of the underwear storage part 690, and a second auxiliary underwear 822 for body shape measurement assistance to manufacture the second underwear such as panties and the like provided on each storage shelf located in the second area 694. In this case, the second auxiliary underwear 822 may refer to girdle-type clothes that correct the body type to position the belly fat in the panty area during a 3D scan in case it is difficult to calculate the exact body size for the panty area because the belly fat droops down to the panty area, but is not limited thereto.

The first auxiliary underwear 812 and the second auxiliary underwear 822 may be manufactured for each of a plurality of pre-classified reference body types, and may be divided and stacked for each reference body type on a plurality of storage shelves.

In addition, the plurality of storage shelves as described above are coated with a material having an antibacterial function so that sanitary conditions of the first auxiliary underwear 812 and the second auxiliary underwear 822 stacked on each storage shelf can be optimally maintained. The material having such an antibacterial function may be formed by mixing, for example, 0.5 to 0.7 parts by weight of a silver-based inorganic antibacterial agent, which is an agglomerate of silver ions and inorganic metal ions, based on 100 parts by weight of a fluororesin.

In addition, the underwear storage part 690 may be provided with a door for blocking the area in which the disposable measurement auxiliary underwear or tapes are stacked from the outside. The door can be opened or closed by a customer's physical force. In addition, an ultraviolet ray irradiator for irradiating ultraviolet ray for sterilization to the disposable measuring auxiliary underwear or tapes stacked on the underwear storage part 690 when the door is closed may be formed at one side of the underwear storage part 690.

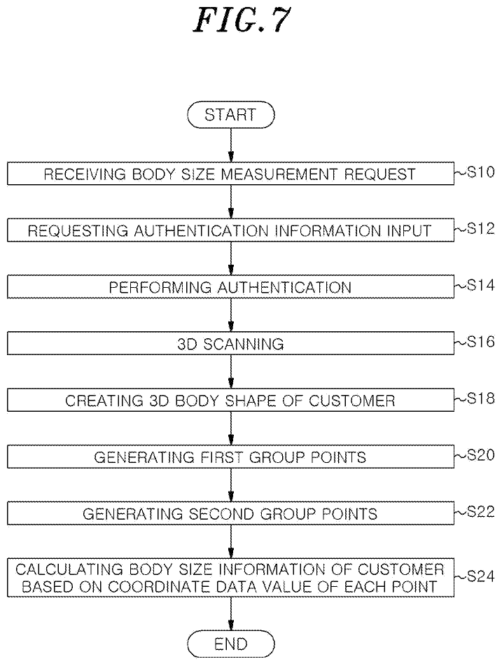

FIG. 7 is a flowchart illustrating an operation control flow for calculating body size information from a 3D body shape of a customer in the body size measuring device according to one embodiment of the present disclosure.

Hereinafter, an operation according to one embodiment of the present disclosure will be described in more detail with reference to FIGS. 1 to 7.

First, when a customer enters the inside of the housing 600 and requests body size measurement through the key input unit 620 or the like (step S10), the body size measuring device 110 recognizes the body size measurement request and requests the customer to input authentication information (step S12).

Accordingly, the customer inputs the authentication information registered as a member in the underwear manufacturing server 100.

Then, the body size measuring device 110 accesses the underwear manufacturing server 100 and authenticates whether the customer is a registered customer through interworking with the underwear manufacturing server 100 (step S14).

Next, the body size measuring device 110 performs a 3D scan on the body of the customer when there is a key input from the customer through the key input unit 620 in as state that the customer is authenticated as a registered customer (step S16), and creates a 3D body shape of the customer (step S18).

Thereafter, the body size measuring device 110 extracts first area points making up a 3D body shape of a preset first area including the bust of the customer among all points making up the 3D body shape of the customer, and generates first group points by selecting a plurality of points necessary for designing a first underwear suitable for the 3D body shape of the first area among the first area points (step S20).

In addition, the body size measuring device 110 extracts second area points making up a 3D body shape of a preset second area including the crotch of the customer among all the points, and generates second group points by selecting a plurality of points necessary for designing a second underwear suitable for the 3D body shape of the second area among the second area points (step S22).

Next, the body size measuring device 110 calculates a plurality of body element information for customized underwear production based on the coordinate data values of the respective points included in the first group points and the second group points, and then calculates the plurality of body elements information as the customer's body size information (step S24).

As described above, according to one embodiment of the present disclosure, in the body size measuring device and system for manufacturing customized underwear, it is possible to, for a customer who wants to make a customized underwear, create a 3D body shape of the customer using a 3D scanner, select points required for customized underwear production among all the points that make up the 3D body shape, calculate coordinate data values of the selected points, and calculate body size information of the customer more accurately based on the coordinate data values of the respective points.

As described above, the present disclosure has been described with reference to the illustrated drawings, but the present disclosure is not limited by the embodiments and drawings disclosed in this specification, and various modifications may be made by those skilled in the art within the scope of the technical spirit of the present disclosure. Further, although the effects according to the configuration of the present disclosure have not been explicitly described while describing the embodiments of the present disclosure, it is natural that the effects predictable by the configuration should also be recognized.

The body size measuring device for manufacturing customized underwear according to the present disclosure can be used to produce customized underwear that can increase customer satisfaction by generating a design suitable for a body shape of a customer.

What is claimed is:

1. A body size measuring device for manufacturing customized underwear for a customer, comprising:
a communication unit connected through a wired/wireless communication network to an underwear manufacturing server that manages authentication information registered as a member of the customer to transmit and receive data;
a key input unit provided with a plurality of function keys for performing various operations of the body size measuring device;
a display unit configured to display operation state information of the body size measuring device according to a key input through the key input unit;
a customer authentication unit serving to authenticate whether the customer is a registered customer by accessing the underwear manufacturing server through the communication unit when there is a request for body size measurement from the customer;
a three-dimensional (3D) scan unit configured to three-dimensionally scan a body of the customer to generate a 3D body shape of the customer when there is a key input for requesting body size measurement from the customer through the key input unit in a state in which the customer is authenticated as a registered customer;
a body size calculation unit that selects a preset number of points necessary for designing underwear suitable for a body shape of the customer from points making up the 3D body shape, and calculates body size information of the customer for manufacturing customized underwear based on a data value of each of the selected points; and
a housing in which the customer enters and stands in a stationary state or through which the customer walks to pass, the 3D scanning unit being installed inside or outside of the housing to enable 3D scanning of the customer.

2. The device of claim 1, wherein when there is a request for body size measurement from the customer, the customer authentication unit receives authentication information from the customer through the key input unit, transmits the authentication information the underwear manufacturing server through the communication unit to transmit an authentication information confirmation request about whether the customer is a registered customer, and when receiving an authentication information confirmation response indicating that the customer is a registered customer through the authentication information from the underwear manufacturing server, authenticates the customer as a registered customer.

3. The device of claim 2, wherein the body size calculation unit transmits, when the body size information of the customer is calculated, the calculated body size information and the authentication information of the customer to the underwear manufacturing server through the communication unit, and
wherein the underwear manufacturing server manages the body size information of the customer as body size information for the customer corresponding to the authentication information.

4. The device of claim 3, wherein the body size calculation unit selects a preset number of points necessary for designing underwear suitable for the body shape of the customer from points making up the 3D body shape, calculates coordinates data values indicating positions on the 3D body shape of the customer for the respective selected points, calculates a plurality of body element information for customized underwear production based on the calculated coordinate data values, and calculates the plurality of body element information as the body size information of the customer.

5. The device of claim 4, wherein the body size calculation unit comprises:
a first group point generating unit that extracts first area points making up a 3D body shape of a preset first area including the customer's bust from among all the points making up the 3D body shape of the customer, and generates first group points by selecting a plurality of points necessary for designing a first underwear suitable for the 3D body shape of the first area among the first area points;
a second group point generating unit that extracts second area points making up a 3D body shape of a preset second area including the customer's crotch from all the points, and generates second group points by selecting a plurality of points necessary for designing a second underwear suitable for the 3D body shape of the second area among the second area points; and
a body size generating unit that calculates a plurality of body element information for customized underwear production for the customer based on coordinate data values of the respective points included in the first group points and the second group points, and then calculates the plurality of body element information as the body size information of the customer.

6. The device of claim 5, wherein the body element information includes first body element information necessary for designing the first underwear and second body element information necessary for designing the second underwear,
wherein the first body element information includes data items having a breast width of a straight length between both nipple points; a front chest center gap between breasts which is a width between the breasts at a first point to a sixth point from a front length of bust circumferences among equidistant points obtained by dividing a distance between the front length of the bust circumference and a front length of a lower bust circumference into 10 equal parts; the bust circumference of a horizontal circumference line passing through the nipple points; the front length of the bust circumference, which is a length corresponding to a front side in the bust circumference with reference to a cross-section length passing through a center of the body; a back length of the bust circumference, which is a length corresponding to a back side in the bust circumference with reference to the cross-section length passing through the center of the body; a breast length obtained by dividing ½ of a front length of an upper bust circumference into 20 equal parts and measuring a vertical length passing through the nipple points from one point selected among the sixth to fourteenth points along a curved line; a breast thickness, which is a thickness of breast with reference to the nipple points; a lower breast height, which is a curved length from the nipple points to a bottom point of the breast; a front length of breast, which is a curved length from the nipple points to the front chest center gap; a back length of breast, which is a horizontally measured curved distance from the nipple points to a point where a vertical line of an end point of an arm meets in a line corresponding to the front length of bust circumference; a front length of breast circumference, which is a curved length of the lower bust circumference from one point selected between a fifth equidistant point to a tenth equidistant point among points obtained by dividing a ½ length of the front length of lower bust circumference into 20 equal parts, to the front chest center gap; a back length of breast circumference, which is a curve length of the lower breast circumference from one point selected between the fifth to tenth equidistant points, among points obtained by dividing a ½ length of the front length of lower bust circumference into 20 equal parts, to one point selected between the fourth to ninth equidistant points among points by dividing a vertical length between an end point of an upper bust circumference and an end point of the front length of lower bust circumference; the upper bust circumference which is a horizontal circumference passing through an end point of an armpit; the front length of the upper bust circumference, which is a length corresponding to a front side in the upper bust circumference with reference to the cross-section length; a back length of the upper bust circumference, which is a length corresponding to a back side in the upper bust circumference with reference to the cross-section length, a total shoulder width between end points of left and right shoulder blades; a shoulder length from a most curved portion at the boundary between a neck and a shoulder to the end point of the shoulder blade; a lower breast circumference, which is a horizontal circumference line at a point where the breast ends; the front length of lower bust circumference, which is a length corresponding to the front side in the lower bust circumference with reference to the cross-section length; a back length of lower bust circumference, which is a length corresponding to a back side in the lower bust circumference with reference to the cross-section length; a breast length between shoulder and the nipple points, which is a vertical length from a seventh point to a fourteenth point in 20 equal parts of the shoulder length to the nipple point; a shoulder center point, which is a midpoint between a neck side point and an end point of the shoulder blade; and a front shoulder strap length, which is a length connecting the seventh point to fourteenth point in the 20 equal parts of the shoulder length to a fifth point to a tenth point in 20 equal parts of ½ length of the front length of upper bust circumference,
wherein the first group points include a set of points necessary to generate the first body element information among the first area points, and
wherein the body size generating unit generates a value of each data item included in the first body element information based on a coordinate data value of each point included in the first group points.

7. The device of claim 6, wherein the second body element information includes:
a first hip circumference which is a circumference at a most protruding point of the hip when viewed from the side; a second hip circumference which is a length corresponding to the front side of the first hip circumference with reference to the cross-section length; a third hip circumference which is a length corresponding to a back side of the first hip circumference with reference to the cross-section length; a lower hip tip distance which is a length of left and right spacing of intersection of a first hip length, a second hip length and a back length of a thigh circumference; a crotch upper width which is a width at the point where the vulva starts in a standing posture with the legs spread to a width of a pelvis; a minimum crotch width which is a length of the width between the left and right sides of the thigh circumference; a leg circumference which is a leg circumference between the fourth to eighth points in 10 equal parts of a vertical interval between a belly circumference and the first hip circumference; the thigh circumference measured at a point 1 cm below a tip of a huckle bone; a back thigh circumferential length measured at a point just below the tip of the huckle bone; a first hip length of a line connecting the sixth to tenth points among equidistant points obtained by dividing a ½ length of back length of the belly circumference into 20 equal parts and a fifth point to a tenth point among equidistant points obtained by dividing the back thigh circumferential length into 20 equal parts; a second hip length of a line connecting a sixth point to a tenth point among equidistant points obtained by dividing a ½ length of back length of a lower belly circumference into 20 equal parts and a fifth point to a tenth point among equidistant points obtained by dividing the back thigh circumferential length into 20 equal parts; a first crotch length from a top of a crotch to the lower belly circumference; a second crotch length from the top of the crotch to the belly circumference; a waist circumference which is a horizontal circumference of a narrowest portion of a waist when viewed from the front; a front circumferential waist length corresponding to the front side of the waist circumference with reference to the cross-section length; a back circumferential waist length corresponding to a back side of the waist circumference with reference to the cross-section length; a lower belly circumference between one selected point among the points obtained by dividing the vertical length between the waist circumference and the first hip circumference into 20 equal parts and the fifth to twelfth equidistant points from the waist circumference; a front lower belly circumferential length corresponding to a front side of the lower belly circumference with reference to the cross-section length; a back lower belly circumferential length corresponding to a back side of the lower belly circumference with reference to the cross-section length; a belly circumference which is a circumference of a most protruding portion of a belly when viewed from a side; a front belly circumferential length corresponding to a front side of the belly circumference with reference to the cross-section length, a back belly circumferential length corresponding to the back side of the belly circumference with reference to the cross-section length; and a pelvic bone length of an interval between left and right pelvic bones,
wherein the second group points include a set of points necessary to generate the second body element information among the second area points, and
wherein the body size generating unit generates a value of each data item included in the second body element information based on a coordinate data value of each point included in the second group points.

8. The device of claim 6, wherein the first body element information further includes: a front neck length of a vertical length from a front neck point to the upper bust circumference; an armhole length from a shoulder end point to an armpit end point; an armhole circumference of an arm circumference; a shoulder strap side length of a curved length between an arm end line and a back arm end line with reference to the armpit end point; a back shoulder strap length connecting the seventh to fourteenth points in 20 equal parts of the shoulder length and the fifth to tenth points in 20 equal parts of ½ length of the back length of the bust circumference; a back shoulder length connecting the seventh to fourteenth points in 20 equal parts of the shoulder length and the fifth to tenth points in 20 equal parts of ½ length the back length of under the bust circumference, a back length from the center of the back neck point to the back length of under the bust circumference in a back body center line; and a front center length from the center of the front neck point to the front center of the under the bust circumference in a front body center line.

9. The device of claim 5, wherein the housing has a sealed interior space in which the customer stands,
the interior space includes a first space in which the customer takes off clothes, and a second space separated from the first space through a space separation member to perform a 3D scan of the body of the customer,
a foot plate on which the customer is located for the 3D scan is placed in the center of the second space,
the foot plate is provided with a pressure sensor for sensing whether the customer is located, and
the 3D scanner three-dimensionally scans the body of the customer only when it is confirmed that the customer is located on the foot plate through the pressure sensor.

10. The device of claim 9, wherein the first space includes an underwear storage part in which tapes or disposable measurement auxiliary underwear to be worn by the customer to assist in measuring the body shape of the customer are stacked, and an underwear collection part that collects the tape or the disposable measurement auxiliary underwear worn by the customer during a 3D scan.

11. The device of claim 10, wherein the underwear storage part includes a plurality of storage shelves,
the disposable measurement auxiliary underwear includes a first auxiliary underwear for assisting body shape measurement for manufacture of the first underwear, and a second auxiliary underwear for assisting body shape measurement for manufacture of the second underwear, and
the first auxiliary underwear and the second auxiliary underwear are manufactured by a plurality of pre-classified reference body types, and are divided and stacked for each reference body type on the plurality of storage shelves.

12. The device of claim 11, wherein the plurality of storage shelves is coated with an antibacterial material, and
wherein the material is formed by mixing 0.5 to 0.7 parts by weight of a silver-based inorganic antibacterial agent, which is an agglomerate of silver ions and inorganic metal ions, based on 100 parts by weight of a fluororesin.

13. The device of claim 10, wherein the underwear storage part has a door for blocking an area in which the disposable measurement auxiliary underwear or tapes are stacked from an outside, and
the door is opened or closed by a physical force of the customer, and
an ultraviolet irradiation unit is provided at one side of the underwear storage part, the ultraviolet irradiation unit irradiating ultraviolet rays to the disposable measuring auxiliary underwear or tapes stacked in the underwear storage part when the door is closed.

14. The device of claim 3, wherein the key input unit further includes a biometric information input unit capable of inputting biometric information of the customer, and
when there is a key input for requesting body size measurement from the customer through the key input unit in a state that the customer is authenticated as a registered customer, the 3D scan unit receives the biometric information of the customer through the biometric information input unit and provides the biometric information of the customer to the body size calculation unit,
the body size calculation unit transmits, when the body size information of the customer is calculated, the calculated body size information of the customer, the authentication information, and the biometric information to the underwear manufacturing server through the communication unit, and
the underwear manufacturing server stores the biometric information and the body size information of the customer associated with each other, and when there is a request for the body size information from the customer, requests the customer to transmit the biometric information together with the authentication information and provides the body size information to the user terminal of the customer when both the authentication information and the biometric information match.

15. A body size measuring system for manufacturing customized underwear for a customer, the system comprising:
a user terminal of a customer through which the customer accesses an underwear manufacturing server implemented on a wired/wireless communication network to register as a member;
an underwear manufacturing server that registers the customer, who wants to produce customized underwear, according to member information input from the user terminal as a member, and manages body size information of the customer registered as a member;
and a body size measuring device for three-dimensionally scanning a body of the customer, generating the body size information of the customer for manufacturing the customized underwear, and transmitting the body size information to the underwear manufacturing server,
wherein the body size measuring device includes:
a communication unit connected through a wired/wireless communication network to an underwear manufacturing server that manages authentication information registered as a member of the customer to transmit and receive data;
a key input unit provided with a plurality of function keys for performing various operations of the body size measuring device;
a display unit configured to display operation state information of the body size measuring device according to a key input through the key input unit;
a customer authentication unit serving to authenticate whether the customer is a registered customer by accessing the underwear manufacturing server through the communication unit when there is a request for body size measurement from the customer;
a three-dimensional (3D) scan unit configured to three-dimensionally scan a body of the customer to generate a 3D body shape of the customer when there is a key input for requesting body size measurement from the customer through the key input unit in a state in which the customer is authenticated as a registered customer;
a body size calculation unit that selects a preset number of points necessary for designing underwear suitable for a body shape of the customer from points making up the 3D body shape, and calculates body size information of the customer for manufacturing customized underwear based on a data value of each of the selected points; and
a housing in which the customer enters and stands in a stationary state or through which the customer walks to pass, the 3D scanning unit being installed inside or outside of the housing to enable 3D scanning of the customer.

16. The system of claim 15, wherein the body size calculation unit transmits, when the body size information of the customer is calculated, the calculated body size information and the authentication information of the customer to the underwear manufacturing server through the communication unit, and
the underwear manufacturing server manages the body size information of the customer as body size information for the customer corresponding to the authentication information.

17. The system of claim 16, wherein the body size calculation unit selects a preset number of points necessary for designing underwear suitable for the body shape of the customer from all the points making up the 3D body shape, calculates coordinates data values indicating positions on the 3D body shape of the customer for the respective selected points, calculates a plurality of body element information for customized underwear production based on the calculated coordinate data values, and calculates the plurality of body element information as the body size information of the customer.

18. The system of claim 17, wherein the body size calculation unit comprises:
a first group point generating unit that extracts first area points making up a 3D body shape of a preset first area including the customer's bust from among all the points making up the 3D body shape of the customer, and generates first group points by selecting a plurality of points necessary for designing a first underwear suitable for the 3D body shape of the first area among the first area points;
a second group point generating unit that extracts second area points making up a 3D body shape of a preset second area including the customer's crotch from all the points, and generates second group points by selecting a plurality of points necessary for designing a second underwear suitable for the 3D body shape of the second area among the second area points; and
a body size generating unit that calculates a plurality of body element information for customized underwear production for the customer based on coordinate data values of the respective points included in the first group points and the second group points, and then calculates the plurality of body element information as the body size information of the customer.

19. The system of claim 18, wherein the body element information includes first body element information necessary for designing the first underwear and second body element information necessary for designing the second underwear,
wherein the first body element information includes data items having a breast width of a straight length between both nipple points; a front chest center gap between breasts which is a width between the breasts at a first point to a sixth point from a front length of bust circumferences among equidistant points obtained by dividing a distance between the front length of the bust circumference and a front length of a lower bust circumference into 10 equal parts; the bust circumference of a horizontal circumference line passing through the nipple points; the front length of the bust circumference, which is a length corresponding to a front side in the bust circumference with reference to a cross-section length passing through a center of the body; a back length of the bust circumference, which is a length corresponding to a back side in the bust circumference with reference to the cross-section length passing through the center of the body; a breast length obtained by dividing ½ of a front length of an upper bust circumference into 20 equal parts and measuring a vertical length passing through the nipple points from one point selected among the sixth to fourteenth points along a curved line; a breast thickness, which is a thickness of breast with reference to the nipple points; a lower breast height, which is a curved length from the nipple points to a bottom point of the breast; a front length of breast, which is a curved length from the nipple points to the front chest center gap; a back length of breast, which is a horizontally measured curved distance from the nipple points to a point where a vertical line of an end point of an arm meets in a line corresponding to the front length of bust circumference; a front length of breast circumference, which is a curved length of the lower bust circumference from one point selected between a fifth equidistant point to a tenth equidistant point among points obtained by dividing a ½ length of the front length of lower bust circumference into 20 equal parts, to the front chest center gap; a back length of breast circumference, which is a curve length of the lower breast circumference from one point selected between the fifth to tenth equidistant points, among points obtained by dividing a ½ length of the front length of lower bust circumference into 20 equal parts, to one point selected between the fourth to ninth equidistant points among points by dividing a vertical length between an end point of an upper bust circumference and an end point of the front length of lower bust circumference; the upper bust circumference which is a horizontal circumference passing through an end point of an armpit; the front length of the upper bust circumference, which is a length corresponding to a front side in the upper bust circumference with reference to the cross-section length; a back length of the upper bust circumference, which is a length corresponding to a back side in the upper bust circumference with reference to the cross-section length, a total shoulder width between end points of left and right shoulder blades; a shoulder length from a most curved portion at the boundary between a neck and a shoulder to the end point of the shoulder blade; a lower breast circumference, which is a horizontal circumference line at a point where the breast ends; the front length of lower bust circumference, which is a length corresponding to the front side in the lower bust circumference with reference to the cross-section length; a back length of lower bust circumference, which is a length corresponding to a back side in the lower bust circumference with reference to the cross-section length; a breast length between shoulder and the nipple points, which is a vertical length from a seventh point to a fourteenth point in 20 equal parts of the shoulder length to the nipple point; a shoulder center point, which is a midpoint between a neck side point and an end point of the shoulder blade; and a front shoulder strap length, which is a length connecting the seventh point to fourteenth point in the 20 equal parts of the shoulder length to a fifth point to a tenth point in 20 equal parts of ½ length of the front length of upper bust circumference,
wherein the first group points include a set of points necessary to generate the first body element information among the first area points, and
wherein the body size generating unit generates a value of each data item included in the first body element information based on a coordinate data value of each point included in the first group points.

20. The system of claim 19, wherein the second body element information includes:
a first hip circumference which is a circumference at a most protruding point of the hip when viewed from the side; a second hip circumference which is a length corresponding to the front side of the first hip circumference with reference to the cross-section length; a third hip circumference which is a length corresponding to a back side of the first hip circumference with reference to the cross-section length; a lower hip tip distance which is a length of left and right spacing of intersection of a first hip length, a second hip length and a back length of a thigh circumference; a crotch upper width which is a width at the point where the vulva starts in a standing posture with the legs spread to a width of a pelvis; a minimum crotch width which is a length of the width between the left and right sides of the thigh circumference; a leg circumference which is a leg circumference between the fourth to eighth points in 10 equal parts of a vertical interval between a belly circumference and the first hip circumference; the thigh circumference measured at a point 1 cm below a tip of a huckle bone; a back thigh circumferential length measured at a point just below the tip of the huckle bone; a first hip length of a line connecting the sixth to tenth points among equidistant points obtained by dividing a ½ length of back length of the belly circumference into 20 equal parts and a fifth point to a tenth point among equidistant points obtained by dividing the back thigh circumferential length into 20 equal parts; a second hip length of a line connecting a sixth point to a tenth point among equidistant points obtained by dividing a ½ length of back length of a lower belly circumference into 20 equal parts and a fifth point to a tenth point among equidistant points obtained by dividing the back thigh circumferential length into 20 equal parts; a first crotch length from a top of a crotch to the lower belly circumference; a second crotch length from the top of the crotch to the belly circumference; a waist circumference which is a horizontal circumference of a narrowest portion of a waist when viewed from the front; a front circumferential waist length corresponding to the front side of the waist circumference with reference to the cross-section length; a back circumferential waist length corresponding to a back side of the waist circumference with reference to the cross-section length; a lower belly circumference between one selected point among the points obtained by dividing the vertical length between the waist circumference and the first hip circumference into 20 equal parts and the fifth to twelfth equidistant points from the waist circumference; a front lower belly circumferential length corresponding to a front side of the lower belly circumference with reference to the cross-section length; a back lower belly circumferential length corresponding to a back side of the lower belly circumference with reference to the cross-section length; a belly circumference which is a circumference of a most protruding portion of a belly when viewed from a side; a front belly circumferential length corresponding to a front side of the belly circumference with reference to the cross-section length, a back belly circumferential length corresponding to the back side of the belly circumference with reference to the cross-section length; and a pelvic bone length of an interval between left and right pelvic bones,
wherein the second group points include a set of points necessary to generate the second body element information among the second area points, and
wherein the body size generating unit generates a value of each data item included in the second body element information based on a coordinate data value of each point included in the second group points.

21. The system of claim 18, wherein when there is a request for body size measurement from the customer, the customer authentication unit receives authentication information from the customer through the key input unit, transmits the authentication information the underwear manufacturing server through the communication unit to transmit an authentication information confirmation request about whether the customer is a registered customer, and when receiving an authentication information confirmation response indicating that the customer is a registered customer through the authentication information from the underwear manufacturing server, authenticates the customer as a registered customer.
